(19) United States
(12) Patent Application Publication
(10) Pub. No.: US 2015/0055741 A1
(43) Pub. Date: Feb. 26, 2015

(54) Device for Obtaining Monochromatic Neutron Radiation

(71) Applicant: Alexander Potemkin, Barsbuettel (DE)

(72) Inventor: Alexander Potemkin, Barsbuettel (DE)

(21) Appl. No.: 14/367,801

(22) PCT Filed: Dec. 21, 2011
(86) PCT No.: PCT/IB2011/003219

§ 371 Date: Oct. 31, 2014

(51) Int. Cl. G21B 3/00; H05H 3/06

(52) U.S. Cl. CPC G21B 3/006; H05H 3/06
USPC 376/146; 376/150

(57) ABSTRACT

An assembly and to a device for obtaining monochromatic neutron radiation is provided. In order to realize a nuclear synthesis reaction, a starting material is introduced into a pressure booster (gas multiplier) and compressed to the pressure at which the synthesis reaction begins. The resulting neutron radiation passes through the seals of the multiplier elements and an outlet channel in the plug of the pressure chamber (gasostat) vessel, then onto a monochromator and further onto the irradiated object.

Sources of optical (photon) radiation are known (lasers on the basis of monocrystals of ruby, fianite (zirconium dioxide) or the like and masers on the basis of adiabatically expanded, overheated gases). However, on account of the strong absorption of this radiation in dense media, the use thereof is limited to the treatment of materials at close range for the purpose of destruction or surface treatment. Attempts to create stronger sources in order for the radiation to take effect over a greater distance fail due to the strong increase in the output power, the implementation of the focusing operations, etc. A couple of researchers have been working in the development of x-ray lasers on the basis of isotopic gamma radiation sources (cobalt 60) or according to the principle of x-ray sources quite a long time now. The advantage of x-ray and gamma sources over optical monochromatic sources is obvious: the short-wave radiation thereof penetrates dense materials, and therefore it is nowadays widely used in the defectoscopy of steel parts having a wall thickness of 150-250 mm. However, this consumes a lot of energy (400-450 kW). To date, all attempts to produce a focused monochromatic x-ray or gamma ray bundle have failed due to the problems in connection with the monochromators and the (mirror or lens) focusing. Taking into account the listed difficulties, a composition and device for collecting monochromatic neutron radiation is now proposed here which has the same high degree of penetration, does virtually not scatter in any media and does not require a large amount of energy to realize the nuclear synthesis process.

### EXAMPLE

The pressure chamber (gasostat) for helium pressures of up to 2000 MPa is produced from high-strength titanium alloys.

1. The inner shell of the pressure chamber is made of the alloy MARagening 350.

2. The punches of the pressure booster are made from a rhenium alloy including 5 % of tungsten (Re+5 % of W) by electron beam melting and electro-erosion followed by the concluding grinding of templates and counter-templates.

3. The gaskets between the punches of the pressure booster (multiplicator) are made hydrostatically from a powder of turbostratic ¹¹B¹⁵N, which was enriched with 1.5-2.3 % by weight of He in a gas pressure chamber, at a pressure of 500-600 MPa up to a density of 1.8-2.2 g/cm³.

4. The outlet channel in the plug of the pressure chamber is closed with a strand of a composite material which is a powder of turbostratic ¹¹B¹⁵N including 1.5-2.3% by weight of He, which is equipped with up to 18 % by volume of nano wires that are oriented perpendicularly to the axis of the outlet channel and that are made from Al¹⁵N.

5. In order to produce the pressure booster shell consisting of two hemispheres, a sheet which is made of a Zr alloy including 2 % of Nb and has a thickness of 1.7 mm is isothermally hot-pressed and then electrochemically polished.

6. The starting material for the nuclear synthesis is obtained from amine borane, wherein boron is used in the form of the isotope ¹¹B, nitrogen as ¹⁵N and hydrogen as tritium with the formula ¹¹BT₃¹⁵NT₃; the powder is compacted in the pressure chamber at a pressure of 1700 MPa by deuterium at a temperature of 110° C. Then, a coating of metallic californium is applied in the evaporation-condensation method up to a thickness of 125 μm.

7. The pressure booster provided with the nuclear starting material is hermetically sealed in a shell, introduced into the pressure chamber and evacuated to 10⁻⁶ torr. Then, helium is pumped in by the following steps:
up to 100 MPa for 30 min, up to 1000 MPa for 45 min, up to 2000 MPa for 60 minutes.

8. The detector for determining the wavelength and density of the neutron flux is placed at a distance of 1 m from the outlet opening of the monochromator:
the enlargement of the spot on the paper for monitoring the radiation does not exceed 0.1-0.2 mm,
during the process, the particle size varies at intervals of 1016→10¹⁴ p/cm²,
the duration of the glowing of a core is no longer than 1.5-1.6 min,
the “burn-up” coefficient of the starting material is up to 18% of the core volume.

1-9. (canceled)

10. A device for obtaining monochromatic neutron radiation, comprising:
a nuclear synthesis reaction starting material;
a gasostat pressure chamber having an inner shell;
a gas multiplicator pressure booster, the pressure booster having punches; and
a monochromator,
wherein
the gas multiplicator pressure booster is configured to
receive the starting material and to apply pressure to compact the starting material to a pressure at which nuclear synthesis reaction begins, and
permit neutron radiation emitted in the nuclear synthesis reaction to pass through at least one gasket between the punches of the pressure booster,
the gasostat pressure chamber includes a plug having an outlet channel configured to permit the emitted neutron radiation to pass through the outlet channel,
the monochromator is configured to receive the emitted neutron radiation passed through the outlet channel prior and emitting the neutron radiation toward a target object.

11. The device according to clam 10, wherein the punches of the pressure booster are made from an electron beam-meted Re-W alloy.

12. The device according to claim 10, wherein the gaskets between the punches of the multiplicator and the outlet channel in the plug of the pressure chamber vessel are made from a turbostratic hexagonal powder made of ¹¹B¹⁵N and having 1.5-2.3% by weight of He and a density of 1.8-2.2 g/cm³.

13. The device according to claim 10, further comprising:
a hermetic shell around the pressure booster,
wherein
the hermetic shell is configured to transfer helium pressure in the pressure chamber to the punches, and
the at least one gasket is made from a sheet of an alloy of Zr+2% of Nb having a thickness of 1.5-2 mm.

14. The device according to claim 13, wherein the starting material for the nuclear synthesis includes amine-borane core having boron is present in the form of the ¹¹B isotope, nitrogen as ¹⁵N and hydrogen as tritium as ¹¹BT₃¹⁵NT₃.

15. The device according to claim 14, wherein the amine-borane synthesis core
has a diameter of 5-7 mm following compaction in the pressure chamber at a pressure of deuterium between 1500-2000 MPa at a temperature of up to 110° C., and has an evaporation-condensation layer of metallic californium up to a thickness of 100-150 μm.

16. The device according to claim 10, wherein the outlet channel in the plug of the pressure chamber is filled by a composite material that is a powder of turbostratic ¹¹B¹⁵N including 1.5-2.3% by weight of He and includes up to 18% by volume of anti-extrusion nano wires made from Al₁₅N aligned vertically to the axis of the outlet channel, the composite material being located in the outlet channel by extrusion at a pressure of 300-350 kg/mm² following compaction at a pressure of 2200-2500 MPa.

17. The device according to claim 14, wherein the pressure chamber is
configured to be evacuated to 10-6 torr with the assembled pressure booster with the core for the nuclear synthesis reaction hermetically sealed in the shell being located within the pressure vessel, and
configured to apply helium pressure to the shell in a pattern of up to 100 MPa for 30 minutes, then up to 1000 MPa for 45 minutes. and then up to 2000 MPa for 60 minutes.

18. A method for obtaining monochromatic neutron radiation using a gasostat pressure chamber having an inner shell, a gas multiplicator pressure booster having punches, a nuclear synthesis reaction starting material and a monochromator, comprising the acts of:
placing the starting material in the pressure booster;
placing the pressure booster in the pressure chamber;
applying pressure in the pressure chamber to the pressure booster to compact the starting material to a pressure at which nuclear synthesis reaction begins;
passing neutron radiation emitted in the nuclear synthesis reaction through at least one gasket between the punches of the pressure booster;
passing the neutron radiation passed through the at least one gasket through an outlet channel of a plug of the pressure chamber;
passing the neutron radiation passed through the outlet channel through the monochromator toward a target object.

19. The method according to clam 18, wherein the punches of the pressure booster are made from an electron beam-meted Re-W alloy.

20. The method according to claim 18, wherein the gaskets between the punches of the multiplicator and the outlet channel in the plug of the pressure chamber vessel are made from a turbostratic hexagonal powder made of ¹¹B¹⁵N and having 1.5-2.3% by weight of He and a density of 1.8-2.2 g/cm³.

21. The method according to claim 18, wherein
the act of applying pressure to the pressure booster includes using a hermetic shell to transfer the helium pressure in the pressure chamber to the punches, and
the at least one gasket is made from a sheet of an alloy of Zr+2% of Nb having a thickness of 1.5-2 mm.

22. The method according to claim 21, wherein the starting material for the nuclear synthesis includes amine-borane core having boron is present in the form of the ¹¹B isotope, nitrogen as ¹⁵N and hydrogen as tritium as ¹¹BT₃¹⁵NT₃.

23. The method according to claim 22, wherein the amine-borane synthesis core is formed by applying a pressure of deuterium between 1500-2000 MPa at a temperature of up to 110° C. to obtain a diameter of 5-7 mm and using a evaporation-condensation process to apply a layer of metallic californium at a thickness of 100-150 μm.

24. The method according to claim 18, wherein the outlet channel in the plug of the pressure chamber is formed by compacting at a pressure of 2200-2500 MPa a composite material that is a powder of turbostratic ¹¹B¹⁵N including 1.5-2.3% by weight of He and includes up to 18% by volume of anti-extrusion nano wires made from Al₁₅N aligned vertically to the axis of the outlet channel, and extruding the composite material into the plug at a pressure of 300-350 kg/mm².

25. The method according to claim 22, wherein the act of applying pressure to the pressure booster includes
evacuating the pressure chamber to 10-6 torr following placement of the assembled pressure booster in the pressure chamber; and
applying the helium pressure to the shell in a pattern of up to 100 MPa for 30 minutes, then up to 1000 MPa for 45 minutes and then up to 2000 MPa for 60 minutes.
